(19) United States
(12) Patent Application Publication
(10) Pub. No.: US 2013/0027489 A1
(43) Pub. Date: Jan. 31, 2013

(54) PRINTING APPARATUS

(71) Applicants: Kazuo Suzuki, Yokohama-shi (JP); Masaya Uetsuki, Yokohama-shi (JP); Toshimitsu Danzuka, Tokyo (JP); Masataka Kato, Yokohama-shi (JP); Tsuyoshi Ibe, Yokohama-shi (JP); Asako Tomida, Kawasaki-shi (JP); Hiroaki Komatsu, Yokohama-shi (JP)

(72) Inventors: Kazuo Suzuki, Yokohama-shi (JP); Masaya Uetsuki, Yokohama-shi (JP); Toshimitsu Danzuka, Tokyo (JP); Masataka Kato, Yokohama-shi (JP); Tsuyoshi Ibe, Yokohama-shi (JP); Asako Tomida, Kawasaki-shi (JP); Hiroaki Komatsu, Yokohama-shi (JP)

(73) Assignee: CANON KABUSHIKI KAISHA, Tokyo (JP)

(21) Appl. No.: 13/558,995

(22) Filed: Jul. 26, 2012

(30) Foreign Application Priority Data
Jul. 29, 2011 (JP) 2011-166761

(51) Int. Cl. B41J 2/01

(52) U.S. Cl. 347/102

(57) ABSTRACT

A printing apparatus includes a printing unit configured to apply ink to a recording medium while reciprocating a print head with respect to the recording medium and a drying unit configured to apply energy for accelerating dryness to the recording medium to which the ink is applied by the print head. The drying unit applies a larger energy at edges of a range within which the printing unit moves on the recording medium than at a middle of the range.

### BACKGROUND OF THE INVENTION

1. Field of the Invention

The present invention relates to a printing apparatus in which a print head applies ink to a recording medium to perform printing.

2. Description of the Related Art

In a serial print system which forms an image while reciprocating a print head, multipass bidirectional printing is known in which printing is performed by performing reciprocal scanning a plurality of times on the same area of the sheet. In this system, a time interval between printing at the time of the first scanning and printing at the time of the second scanning in any continuous two-times scanning is different according to the distance from a position where a carriage inverts its driving direction. For this reason, before an ink droplet applied on the sheet in the first scanning permeates the sheet and is then fixed to the sheet, printing is performed by the second scanning, so that an image at that portion may deteriorate as an uneven streak depending on the characteristics of the sheet.

Japanese Patent Application Laid-Open No. 07-047695 discusses a solution to the above problem such that the carriage is caused to wait for a predetermined time period until the next scanning is started after the forward or backward scanning is ended.

The waiting time period from the end of a scanning to the start of the next scanning merely means the stop of a printing operation. For that reason, it is important to reduce the waiting time as much as possible to improve a print throughput.

### SUMMARY OF THE INVENTION

An aspect of the present invention is directed to a printing apparatus capable of reducing the deterioration of an image due to an insufficient dryness without sacrificing print throughput.

According to an aspect of the present invention, a printing apparatus includes a printing unit configured to apply ink to a recording medium while reciprocating a print head with respect to the recording medium, and a drying unit configured to apply energy for accelerating dryness to the recording medium to which the ink is applied by the print head. The drying unit applies more energy at edges of a range within which the printing unit moves on the recording medium than at a middle of the range.

According to an exemplary embodiment of the present invention, there is provided a printing apparatus capable of reducing the deterioration of an image due to an insufficient dryness without any sacrifice of print throughput. Further, electric power required for drying ink can be minimized.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a perspective view illustrating a configuration of principal units of an inkjet printing apparatus.

FIG. 2 is a side view illustrating a configuration of principal units of the inkjet printing apparatus.

FIG. 3 is a system block diagram of a control unit.

FIG. 4 is a schematic diagram illustrating a relationship in arrangement between a printing unit and a drying unit.

FIGS. 5A, 5B, and 5C illustrate interscanning times in five areas.

FIGS. 6A, 6B, and 6C illustrate temperature and image unevenness on a recording medium.

FIGS. 7A and 7B illustrate interference with adjacent dots.

FIG. 8 illustrates that the interscanning time is different according to positions.

FIGS. 9A, 9B, and 9C illustrate temperature on the recording medium.

FIG. 10 is a schematic diagram illustrating another exemplary embodiment of a drying unit.

### DESCRIPTION OF THE EMBODIMENTS

Various exemplary embodiments, features, and aspects of the invention will be described in detail below with reference to the drawings.

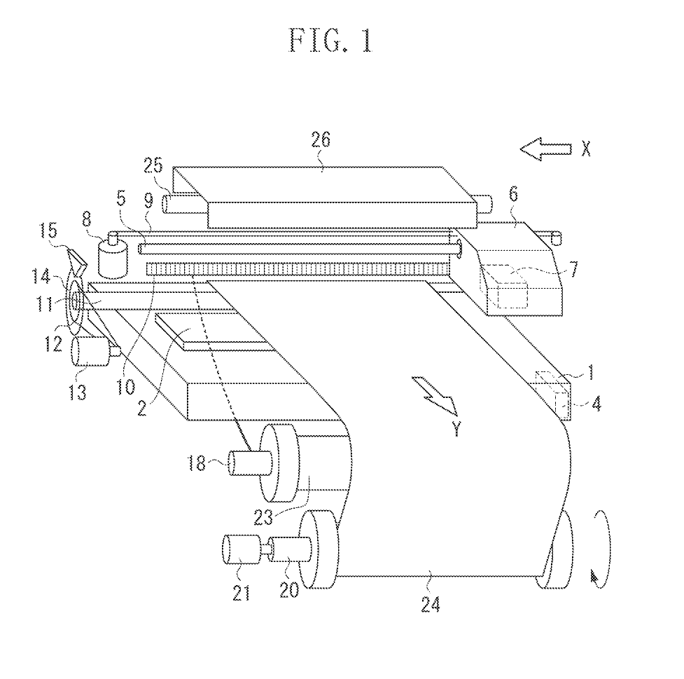

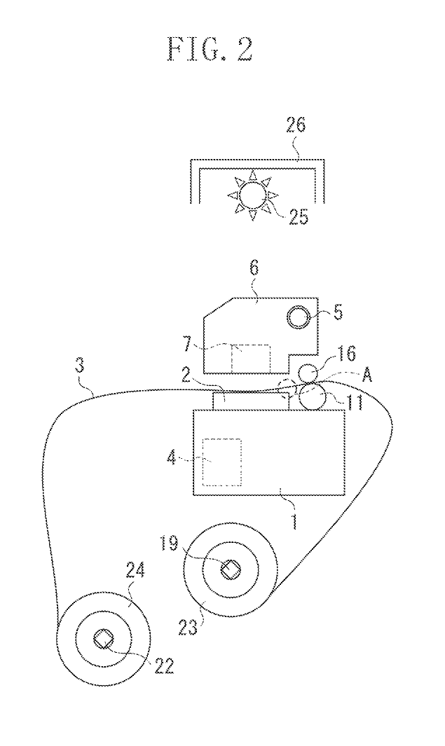

FIG. 1 is a perspective view illustrating a configuration of principal units of an inkjet printing apparatus according to an exemplary embodiment of the present invention. FIG. 2 is a side view thereof. The inkjet printing apparatus principally includes a printing unit, a recording medium conveyance unit, a drying unit, and a control unit.

It is presumed that the recording medium for use in the inkjet printing apparatus according to the present exemplary embodiment is the one made of water repelling vinyl chloride without a receiving layer (hereinafter referred to as recording medium without a receiving layer). A general recording medium with a receiving layer may be used. It is also presumed that the ink in use includes a large amount of polymer emulsion with a property in which moisture in the ink is evaporated by applying heat to the recording medium and the ink is softened and encapsulated. The ink is encapsulated on the recording medium to enable improving weather resistance, water resistance, and scratch resistance of an image.

The printing unit forms an image in a serial print system method in which a carriage 6 repeats the reciprocal scanning of a print head 7 in the main scanning direction (X direction) on the recording medium, which is conveyed on a platen 2 in the sub-scanning direction (Y direction) by step feed.

The platen 2 is mounted on a casing 1. The casing 1 includes a suction unit 4 for suctioning a recording medium 3. The carriage 6, which is reciprocated in the main scanning direction, is supported by a main rail 5 arranged along the longitudinal direction of the casing 1. The carriage 6 is provided with the inkjet print head 7. An energy generation element for discharging ink from the nozzles of the print head 7 may be any of a heating element, a piezoelectric element, an electrostatic element, and a microelectromechanical system (MEMS) element.

A carriage motor 8 is a drive source for moving the carriage 6 in the main scanning direction and the rotation driving force thereof is transmitted to the carriage 6 by a belt 9. A position where the carriage 6 is in the main scanning direction is detected by a linear encoder. The linear encoder includes a linear encoder pattern 10 attached to the casing 1 and a reader (not illustrated) which optically, magnetically, or mechanically reads the encoder pattern 10 and is mounted on the carriage 6.

The recording medium conveyance unit feeds a recording medium, conveys the recording medium in the printing unit, and handles the recording medium at the time of collecting the recording medium. A long continuous recording medium of a recording medium is supplied as a roll member 23 wound onto a spool 18 in a roll shape. The spool 18 includes a torque limiter 19 for exerting a brake force (back tension) on the recording medium 3. The recording medium drawn out from the roll member 23 is supplied to the lower portion of the printing unit (the casing 1) from the front to the rear of the apparatus.

The recording medium 3 supplied to the lower portion of the casing 1 is supplied onto the platen 2 from the rear to the front while winding the casing 1. The recording medium 3 on the platen 2 is conveyed along the sub-scanning direction (direction indicated by an arrow Y in FIG. 1) orthogonal to the main scanning direction of the carriage 6. The conveyance is performed by a drive mechanism composed of a conveyance roller 11, a pinch roller 16, a belt 12, and a conveyance motor 13. The driving state (amount of rotation and rotation speed) of the conveyance roller 11 is detected and monitored by a rotary encoder. The rotary encoder includes a circular encoder pattern 14, which is rotatable with the conveyance roller 11, and a reading unit 15 for optically, magnetically, or mechanically reading the encoder pattern 14.

The recording medium on which an image is printed by the print head 7 of the printing unit is wound and collected by a spool 20. The recording medium wound in a roll shape around the spool 20 forms a roll member 24. The spool 20 is rotated by a winding motor 21 and includes a torque limiter 22 for exerting a winding tension on the recording medium 3.

If the recording medium without a receiving layer is used, the drying unit radiates energy for drying the ink applied to the recording medium in a short time period. The drying unit has a heater 25 provided immediately above the platen 2 and in a position higher than the carriage 6. The heater 25, as described below, is divided into a plurality of heater elements (five elements in the present exemplary embodiment) along the longitudinal direction. The heater 25 is covered by a heater cover 26. The heater cover 26 causes a mirror inside the cover to reflect the heat (infrared to far-infrared) of the heater to direct the heat toward the recording medium surface and physically protects the heater.

The heater 25 is positioned immediately above the platen 2 and radiates thermal energy to the area where the print head 7 is reciprocated. When the ink discharged from the print head 7 reaches the print surface, the carriage 6 immediately leaves there, and the applied ink is exposed to the thermal energy radiated by the heater 25. This accelerates the evaporation and dry of moisture of the ink promptly after printing is performed. The thermal energy of the heater 25 evaporates moisture and dissolves specific components in the ink to cover the color materials of the ink with the specific components. Thus, the ink can be firmly fixed even to the recording medium without a receiving layer to form an image high in weather resistance.

FIG. 3 is a system block diagram of the control unit for controlling the printing apparatus. The central core of the control unit is a computer portion such as a central processing unit (CPU) 302, a read only memory (ROM) 303, and a random access memory (RAM) 104. An input/output interface 301 connects the CPU 302 with an external host computer 300 and allows bidirectional communication based on a predetermined protocol. The drive of various types of a driving motor 306 in the printing apparatus is controlled via the motor driver 305 by instructions from the CPU 302. The drive of the print head 7 is driven by instructions from the CPU 302 via a head driver 307. The heater elements of the heater 25 are separately controlled by instructions from the CPU 302 via a heater driver 308.

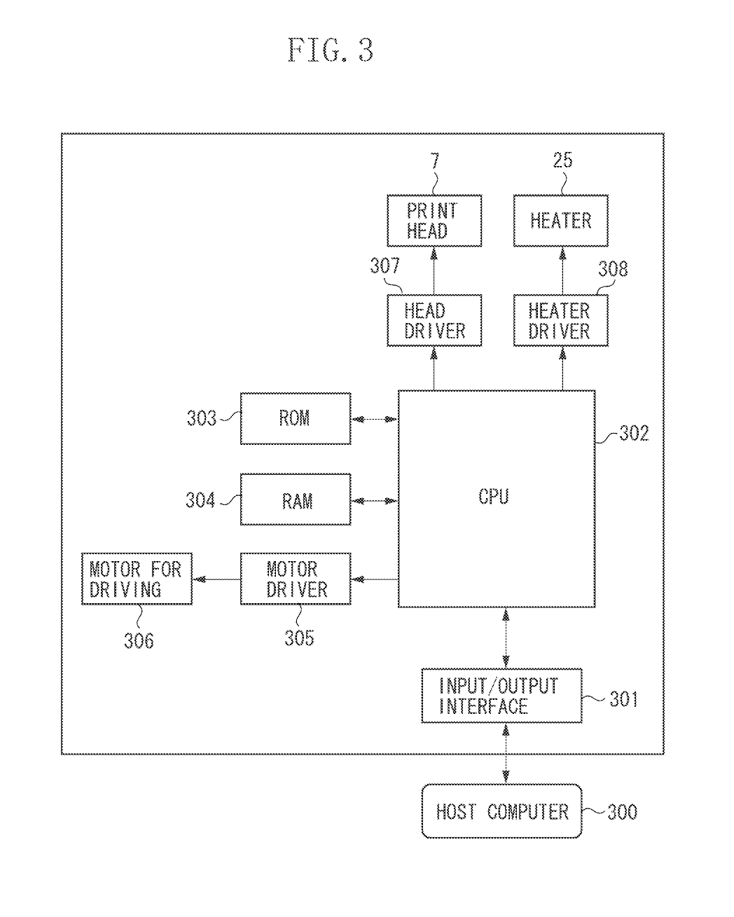

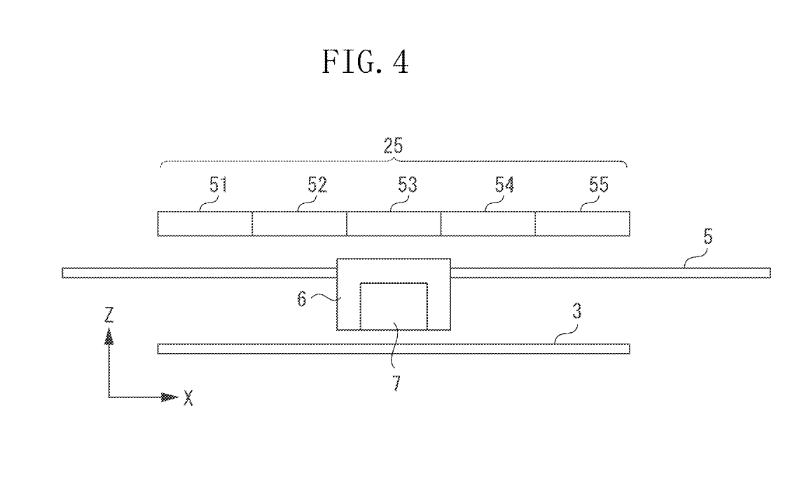

FIG. 4 is a schematic diagram illustrating a relationship in arrangement between the printing unit and the heater 25 of the drying unit. The heater 25 arranged above the recording medium 3 includes five heater elements 51, 52, 53, 54, and 55 equally divided in the main scanning direction, and each element is capable of independently controlling heating temperature.

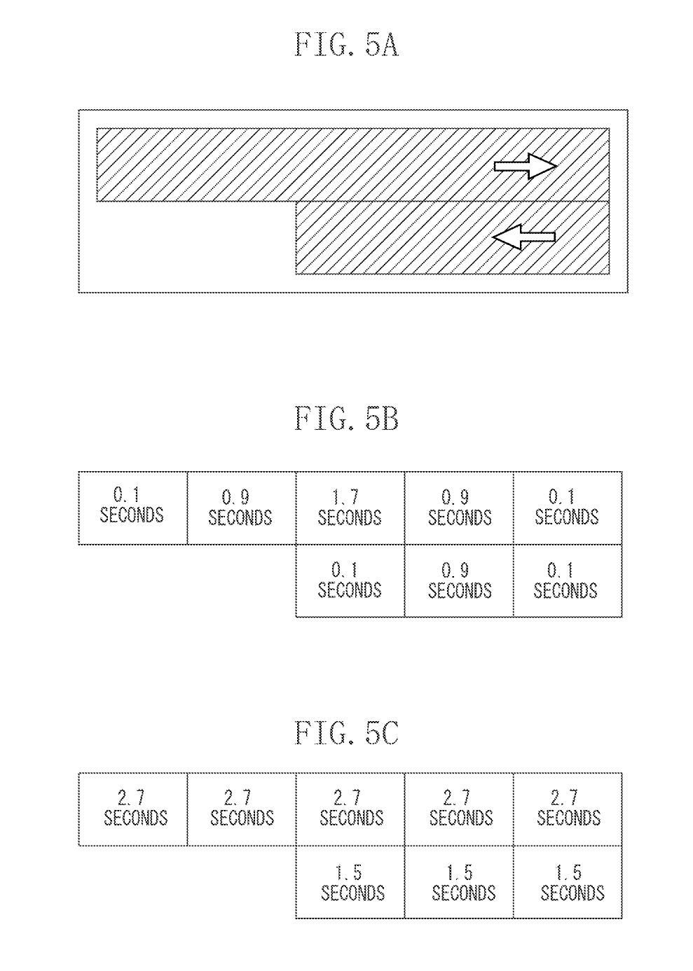

The control unit acquires information about a period of time required until printing is performed in the next scanning after printing is performed in the previous scanning (hereinafter referred to as an interscanning time) for each of the five areas on the recording medium 3 corresponding to the five heater elements. For example, when an image with two bands illustrated in FIG. 5A is bidirectionally printed in the directions indicated by arrows, the interscanning time (minimum value) for each area on the recording medium is provided in FIG. 5B. On the other hand, when the image illustrated in FIG. 5A is unidirectionally printed (the scanning direction on the upper band is opposite to the direction indicated by the arrow), the interscanning time (minimum value) for each area is provided in FIG. 5C. Thus, the interscanning time is different in value according to areas and determined by various types of parameters such as image width, print direction, scanning speed of the print head, and step-feed time for each band of the recording medium. In a precise sense, the interscanning time is slightly different depending on positions in the scanning direction in each area, so that the interscanning time that is the shortest in an area is taken as the typical value of that area. This is because the minimum value of a time period provided for drying (the interscanning time) can be used as a determination parameter for insufficient dryness.

As described above, insufficient thermal energy to be provided for dryness produces image unevenness. However, excessively increasing temperature on the recording medium increases the power consumption of the apparatus, which is not desirable. This also increases the temperature of the recording head to probably affect the discharge performance and lifetime of nozzles. Furthermore, if the recording medium in use is a material weak against heat, such as vinyl chloride, excessive heating may deform the recording medium and cause damage such as creases.

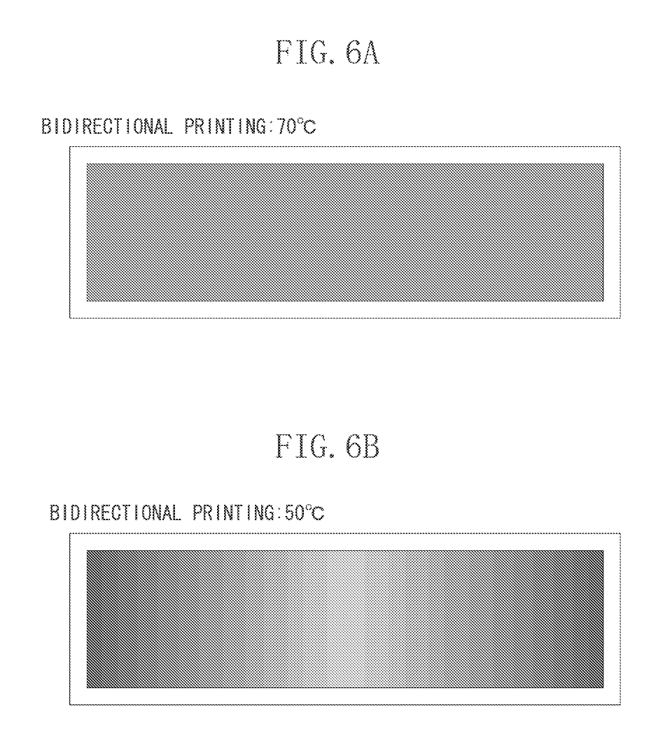

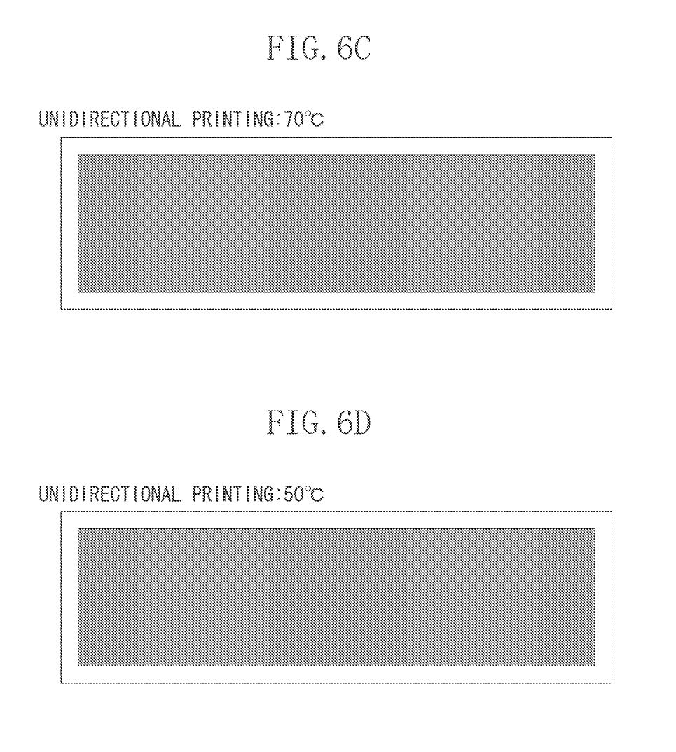

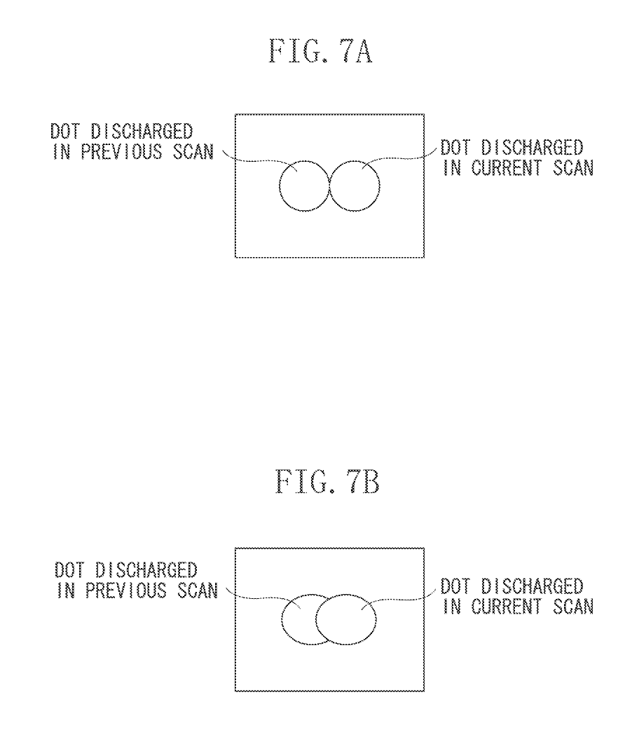

The image unevenness prominently occurs in bidirectional printing in which printing is performed in both of forward and backward scanning while the carriage is reciprocated. On the other hand, the image unevenness slightly occurs in unidirectional printing in which printing is performed in either of forward or backward scanning while the carriage is reciprocated. The reason is described below with reference to FIGS. 6A to 6D and FIGS. 7A and 7B.

In the case of bidirectional printing, in the five divided areas on the recording medium, the nearer an edge area is to the reversing position of scanning (return position), the shorter the interscanning time. For this reason, the possibility that ink is applied in the next scanning before ink applied in the previous scanning is sufficiently dried in the end area is higher than in the other areas. This phenomenon prominently occurs as temperature becomes lower. The ink applied in the previous and the next scanning forms a dot in which adjacent dots are mixed with each other as illustrated in FIG. 7B. In the middle area, there is no such superimposed dot, as illustrated in FIG. 7A. For that reason, the image unevenness occurs in one image and the human eye recognizes the image unevenness as unevenness (refer to FIG. 6B). However, if heat sufficient enough to dry the recording medium in a short time period is provided for the recording medium, the occurrence of the unevenness can be reduced (refer to FIG. 6A).

In the case of unidirectional printing, on the other hand, a time sufficient enough to dry the ink applied in the precious scanning is allowed and the next scanning is performed. For this reason, the ink applied in the previous and the next scanning does not interfere with each other. Every dot in one image is formed in a dot shape as illustrated in FIG. 7A (refer to FIGS. 6C and 6D). The present exemplary embodiment is directed to solving such problem inherent in the bidirectional printing. As a basic concept for solution, a larger energy is provided to the end rather than to the middle in the range in which the print head moves on the recording medium. More specifically, the range in which the print head moves for scanning on the recording medium is segmented into a plurality of areas, and energy provided to each area by the drying unit is set according to a period of time required until printing is performed again in the next scanning after printing is performed in the previous scanning on one area.

In the range in which the print head moves for scanning on the recording medium, for example, the heating value of the heater in the drying unit is set such that, the smaller the area is in the minimum value of the interscanning time, the higher the temperature on the recording medium becomes. Table 1 illustrates a relationship between the minimum value of the interscanning time and the temperature on the recording medium.

TABLE 1

| | Temperature of |
|---|---|
| Interscanning time | recording medium |
| 1.0 sec or more | 50° C. |
| 0.5 sec or more and less | 60° C. |
| than 1.0 sec | |
| less than 0.5 sec | 70° C. |

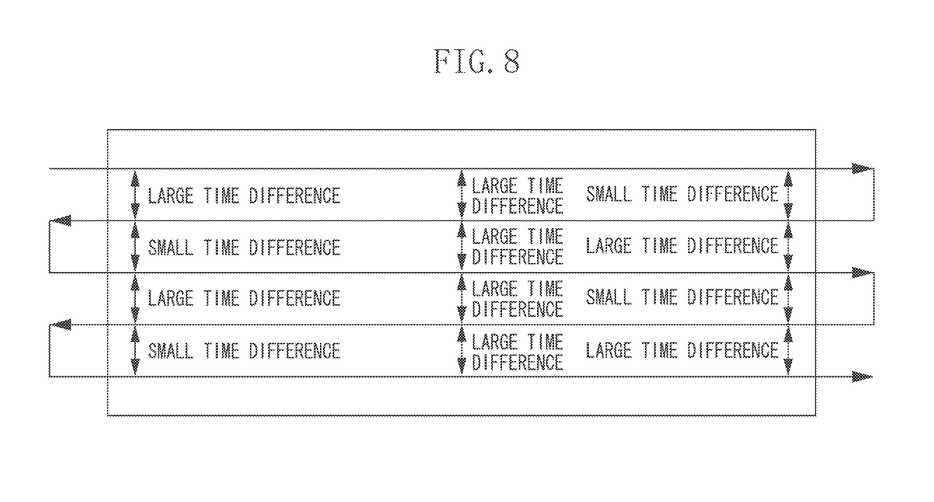

The reason the minimum value of the interscanning time is referenced is described below. In general, inkjet printing uses multipass printing in which an image is formed by scanning the same area on the recording medium more than once. When the bidirectional printing and the multipass printing are performed, as illustrated in FIG. 8, the small and large interscanning times (time differences) are mixed even in the area of one image depending on locations. In the middle portion of scanning, the time difference is large in all scanning operations, but, in both edges of scanning, the large and small time differences are alternated. Because a dry-insufficiency determining factor is a small interscanning time rather than a large interscanning time, the minimum value of the small interscanning time is referenced.

In both edges of scanning where the large and small time differences are alternated, the scanning small in the interscanning time causes a problem, so that the amount of energy applied to the vicinity of both edges (the heating value of the heater) is determined based on the above. Alternatively, the amount of energy applied to the vicinity of both edges may be alternately increased and decreased every scanning.

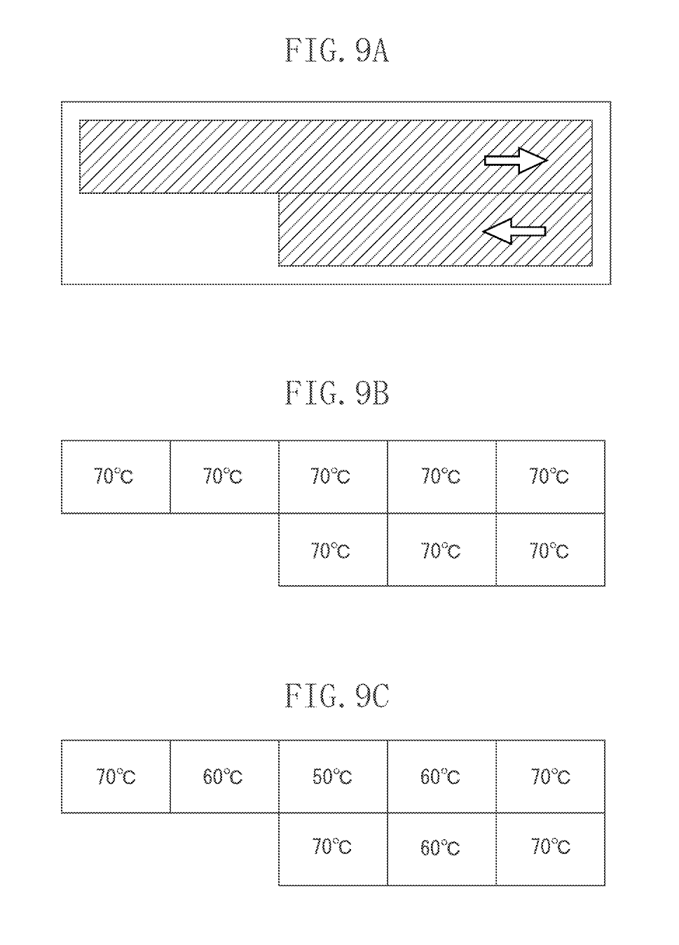

The advantage of the present exemplary embodiment is described by comparing the present exemplary embodiment (in FIG. 9C) with a conventional embodiment (in FIG. 9B) in a case where the image illustrated in FIG. 9A, for example, is bidirectionally printed in the direction indicated by the arrow. In the present exemplary embodiment, the drying unit is set so that, the smaller an area is in the minimum value of the interscanning time among five segmentation areas, the higher the temperature of the recording medium becomes. For example, as illustrated in FIG. 9C, the temperature of the middle area of the recording medium is 50° C., that of an areas adjacent thererto is 50° C., and that of the endmost edges is 70° C. Thus, the recording medium is provided with non-uniform temperature distribution in which temperature is gradually lowered inward as a whole. In a conventional embodiment, on the other hand, as illustrated in FIG. 9B, the temperature of the recording medium is constant (70° C.) in all areas. In the present exemplary embodiment, the power consumption of the heater can be made smaller than that in the conventional embodiment because the inside area is made lower in temperature than both edges. The present exemplary embodiment can be less influential in the discharge performance and lifetime of the nozzle than the conventional embodiment, because heat applied by the drying unit can be prevented from increasing the temperature of the recording head.

The interscanning time for each area can be acquired by measuring the time using a timer or calculating the time. If the time is acquired by calculation, the time can be determined from a scanning speed, a distance from edges of an image, a distance from a print head reversing portion, and a print head reversing time. An example of a calculation formula for determining the interscanning time T is represented by the following equation (1):

Interscanning time T=(distance from a print head reversing portion)×2/(average scanning speed)+(print head reversing time). (1)

The temperature of the recording medium can be controlled to a predetermined temperature by using feedback control or open loop control. For the feedback control, the temperature of the recording medium surface is measured by a temperature sensor to control the output of each heater. For the open loop control, the relationship between the temperature of the recording medium previously determined by an experiment and a heater output is obtained and stored to set the heater output to a predetermined temperature.

The configuration of the heater is not always limited to the above form. For example, such a form may be provided that the heater is formed of a long and thin single element, a shutter for shielding heat is provided for each segmented area, and heat applied to the recording medium is adjusted according to a time period for which the shutter is opened. Alternatively, such a form may be provided that the heater can be moved along the scanning direction.

A drying unit for giving energy for accelerating dryness for the recording medium to which ink is applied by a printing unit may be used irrespective of a form for providing thermal energy (infrared to far-infrared) by a heater. For example, such a form may be provided that the recording medium is irradiated with electromagnetic waves, such as ultraviolet ray, infrared ray, or microwave, or provided with air current (warm wind with low humidity) to accelerate dryness by providing energy.

As described above, the ink applied in the previous and the next scanning interferes with each other on the recording medium to produce the image unevenness. The probability that the image unevenness is produced in an area where dot density is low is relatively low because the probability that the ink applied in the previous and the next scanning is adjacent to each other is low.

Weighting of temperature control on the recording medium performed according to the interscanning time for each area may be performed according to the dot density for each area. If the dot density is low, the temperature control on the recording medium is not performed according to the interscanning time for each area and the temperature control on the recording medium is performed according to the interscanning time for each area as the dot density becomes high. Table 2 illustrates an example of a relationship among the dot density, the minimum value of the interscanning time, and temperature on the recording medium.

TABLE 2

| | Recording medium temperature | | |
|---|---|---|---|
| | Dot density | | |
| | | 10% or more and | |
| Interscanning time | Less than 10% | less than 30% | 30% or more |
| 1.0 sec or more | 50° C. | 50° C. | 50° C. |
| 0.5 sec or more and | 50° C. | 55° C. | 60° C. |
| less than 1.0 sec | | | |
| Less than 0.5 sec | 50° C. | 60° C. | 70° C. |

Thus, the minimum value of the interscanning time and the temperature of the drying unit are controlled according to the dot density for each area to allow power consumption to be reduced and temperature in the apparatus to be further prevented from increasing.

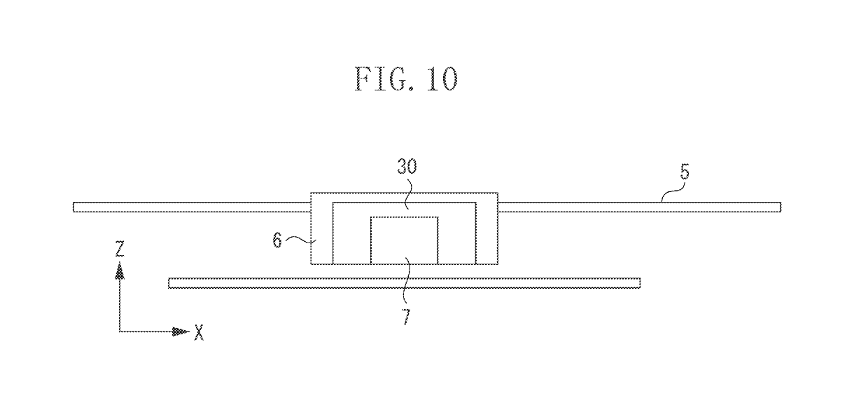

Another modification is described below with reference to FIG. 10. In this example, a drying unit 30 incorporating a single-element heater is mounted on the carriage 6 reciprocating with the print head 7 held. As is the case with the above exemplary embodiment, the interscanning time (minimum value) is acquired for each of a plurality of areas on the recording medium and the output of the heater of the drying unit 30 is controlled such that the smaller the value, the larger the provided drying energy. The higher the scanning speed of the carriage 6, the more insufficient the response of temperature control of the heater may be, so that it is desirable to control the heater earlier by a lag time of response. Table 3 illustrates an example of a relationship between recording medium target temperature and power applied to the drying unit in cases where a drying unit excellent in response is used and a drying unit inferior in response is used.

TABLE 3

| | | Carriage movement direction | | | | |
|---|---|---|---|---|---|---|
| | | Area 1 | Area 2 | Area 3 | Area 4 | Area 5 |
| Target temperature | | 50 | 55 | 60 | 65 | 70 |
| on recording | | | | | | |
| medium (° C.) | | | | | | |
| Power | Excellent | 80 | 85 | 90 | 95 | 100 |
| applied | in | | | | | |
| to | response | | | | | |
| drying | Inferior | 85 | 90 | 95 | 100 | 100 |
| unit (%) | in | | | | | |
| | response | | | | | |

Table 4 illustrates an example of a relationship between recording medium target temperature and power applied to the drying unit according to the carriage speed.

TABLE 4

| | | Carriage movement direction | | | | |
|---|---|---|---|---|---|---|
| | | Area 1 | Area 2 | Area 3 | Area 4 | Area 5 |
| Target temperature | | 50 | 55 | 60 | 65 | 70 |
| on recording | | | | | | |
| medium (° C.) | | | | | | |
| Power | Low | 80 | 85 | 90 | 95 | 100 |
| applied | carriage | | | | | |
| to drying | speed | | | | | |
| unit (%) | High | 85 | 90 | 95 | 100 | 100 |
| | carriage | | | | | |
| | speed | | | | | |

According to the exemplary embodiment described above, a printing apparatus capable of preventing the deterioration of an image due to an insufficient dryness without any sacrifice of print throughput can be realized. Further, Power required for drying ink can be reduced.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-166761 filed Jul. 29, 2011, which is hereby incorporated by reference herein in its entirety.

What is claimed is:

1. A printing apparatus comprising:
a printing unit configured to apply ink to a recording medium while reciprocating a print head with respect to the recording medium; and
a drying unit configured to apply energy for accelerating dryness to the recording medium to which the ink is applied by the print head,
wherein the drying unit applies more energy at edges of a range within which the printing unit moves on the recording medium than at a middle of the range.

2. The printing apparatus according to claim 1, wherein the drying unit applies thermal energy to the recording medium to accelerate dryness of the sheet.

3. The printing apparatus according to claim 1, wherein the range within which the printing unit moves for scanning on the recording medium is segmented into a plurality of areas, and energy to be applied to each of the plurality of areas by the drying unit is set according to a period of time required until printing is performed again in next scanning after printing is performed in previous scanning on the area.

4. The printing apparatus according to claim 3, wherein as a distance from an edge of an image formed on the recording medium or a period of time required for scanning decreases, the more energy the drying unit applies to the recording medium.

5. The printing apparatus according to claim 3, wherein energy to be applied to an area in the vicinity of edges of the image is varied each time the scanning is performed.

6. The printing apparatus according to claim 3, wherein as a distance from a position where the print head reverses a scanning direction or a period of time required for scanning decreases, the more energy the drying unit applies to the recording medium.

7. The printing apparatus according to claim 3, wherein the larger the amount of ink applied to the area, the more energy the drying unit applies to the recording medium.

8. The printing apparatus according to claim 1, wherein the drying unit extends across an area corresponding to the range and is capable of applying energy different from position to position in the range.

9. The printing apparatus according to claim 1, wherein the drying unit is mounted on a carriage included in the printing unit and is capable of varying the amount of energy applied according to movement of the carriage.

10. The printing apparatus according to claim 1, wherein the recording medium does not include a receiving layer for ink and the ink includes polymer emulsion.
